(19) United States
(12) Patent Application Publication
(10) Pub. No.: US 2013/0048227 A1
(43) Pub. Date: Feb. 28, 2013

(54) Portable Height Adjustable Barrier for Screening Off the Source of Traffic Congestion

(71) Applicant: Carl S. Cannova, University Park, FL (US)

(72) Inventor: Carl S. Cannova, University Park, FL (US)

(21) Appl. No.: 13/216,426

(22) Filed: Aug. 24, 2011

(51) Int. Cl. E01F 13/04; G08B 5/38

(52) U.S. Cl. 160/10; 160/327; 160/328; 160/135

(57) ABSTRACT

A portable barrier is provided to obstruct viewing the source of traffic congestion comprising a first vertical assembly, a second vertical assembly and a retractable screen. Each vertical assembly has a top portion, a middle portion, and a base stand. Each middle portion includes at least one tubular barrel capable of receiving the top portion and a female fastener. The retractable screen is drawn from (and may retract into) the first vertical assembly. This retractable screen has one or more partitions which include a plurality of parallel horizontal straps which all attach to a vertical fastener which engages the female fastener located on the second vertical assembly.

### FIELD OF THE INVENTION

The invention generally relates to barriers and more particularly is directed to a portable and scalable height adjustable barrier for screening off an area to reduce gawking proximate traffic congestion.

### BACKGROUND OF THE INVENTION

Traffic congestion is a condition on road networks that occurs as use increases (such as during peak times). Such congestion is characterized by slower speeds and longer trip times. Causes of traffic congestion may include not only roadwork (construction) and increased road use, but also auto accidents. When vehicles are stopped for periods of time, this is often referred to as a traffic jam.

Regardless of cause, traffic congestion can escalate and increase due to driver “gawking.” Gawking occurs when drivers stuck in traffic congestion slow down (despite nearing the cause or end of congestion) to observe what is going on. Often, this is to see a car accident, wreckage, and emergency response vehicles. Regardless, such gawking often magnifies the delays caused by the traffic congestion.

Increased congestion, due to gawking, has opportunity costs including non-productivity of drivers caught in lengthened commutes. Moreover, such delays can cause lost business, disciplinary action or other personal losses. Inability to forecast travel times can cause drivers to allocate more time to travel, again resulting in loss of productivity. This can also lead to increased wear and tear on vehicles. Finally, longer commutes due to gawking causes increased air pollution and carbon dioxide emissions.

While gawking continues to be a significant contributor to traffic congestion, very little has been done to alleviate this problem. One rudimentary solution is disclosed in U.S. Pat. No. 4,124,196 entitled “Portable Device for Screening Off and Accident Scene from View” to Hipskind which addresses a perforated vinyl sheet that can be assembled between two vertical rods. However, the Hipskind device requires one vertical rod to be attached to an emergency vehicle positioned at the source of the congestion. The screen is attached via a U shaped clamp permanently attached to the vehicle bumper to stabilize the sheet.

A second proposed solution to gawking is addressed in U.S. Pat. No. 6,142,701 entitled “Traffic Management System” to Falcon. The Falcon technology teaches use of three vertical posts, two of which include rolled and expandable screens that are dispensed by way of a crank. To ensure stability, the Falcon system however requires a middle vertical pole. Moreover, the Falcon system is limited as it precludes adjustment of vertical height.

Accordingly, there is a need in the art of barriers for a portable height adjustable shield for use to prevent gawking at the cause of traffic congestion. Such shield should be scalable and easily able to adjust for vertical height. Moreover, such screen should be self-sustaining without need to affix to an emergency vehicle.

### SUMMARY OF THE INVENTION

The present invention solves the current limitations in the art of portable barriers used to prevent gawking at the case of traffic congestion. Moreover, this invention (and the embodiments disclosed herein) teach a scalable and vertically height adjustable screen that is self-supporting without need to affix to a rigid body, such as an emergency vehicle or road partition. Such device can be reduced into a portable and compact assembly such that it can be stowed in an emergency vehicle for transport to the site of the traffic congestion. In addition, the invention can be quickly and easily assembled on-site by a single emergency response professional.

The invention is directed to a portable barrier to obstruct viewing a source of traffic congestion and may be described by way of example as comprising three primary components: a first vertical assembly, a second vertical assembly, and a retractable screen positioned between both vertical assemblies. Each vertical assembly has a top portion, a middle portion, and a base stand. Each middle portion includes at least one tubular barrel capable of receiving the top portion and a female fastener.

Optionally, each middle portion may also include an elliptical outer housing having a first tubular barrel and a second tubular barrel. Both barrels are parallel to each other and capable of receiving a top portion. An adjustor key may be positioned along the elliptical outer housing sufficient to regulate the height of the top section. The elliptical outer housing may further include a male fastener on the opposite side of the elliptical housing in comparison to the female fastener. The male fastener is capable of engaging another vertical assembly in order to length the portable barrier. A rotatable crank may be positioned on the first vertical assembly to release (and later return) the retractable screen. The top portion of the vertical assembly may optionally include a warning beacon having a flashing light powered by a battery.

The retractable screen may be drawn from (and may retract into) the first vertical assembly. Moreover, the retractable screen may have one or more partitions which include a plurality of parallel horizontal straps which attach to a vertical fastener which engages the female fastener located on the second vertical assembly. The retractable screen may also include an upper partition positioned within the top portion of the first vertical assembly. In addition, a lower partition is positioned within the middle portion of the first vertical assembly. The retractable screen is made from a flexible, bendable and conforming layer of material.

Positioned below the middle portion is a bottom stand which may comprise a swivel stabilizer having a claw, a hinge which affixes to the middle portion of the vertical assembly and a connecting rod having a sufficient length to affix to claw and the hinge. The claw may include a base and a spike capable of piercing and engaging soft ground.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a perspective view of the portable barrier having height adjustable first and second vertical assemblies;

FIG. 2 is a perspective view of the middle portion of a vertical assembly within the portable barrier;

FIG. 3 is front view of a vertical assembly including both the top and middle portions;

FIG. 4 illustrates one embodiment of the bottom stand for a vertical assembly;

FIG. 5 is a side view of the retractable screen;

FIG. 6 is a is a top perspective view of the first vertical assembly and the retractable screen;

FIG. 7 is a perspective view of the second vertical assembly and the retractable screen;

FIG. 8 illustrates a second embodiment of the bottom stand; and

FIG. 9 is a light module affixed to the top of a vertical assembly of the portable barrier.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overall Components of the Portable Barrier

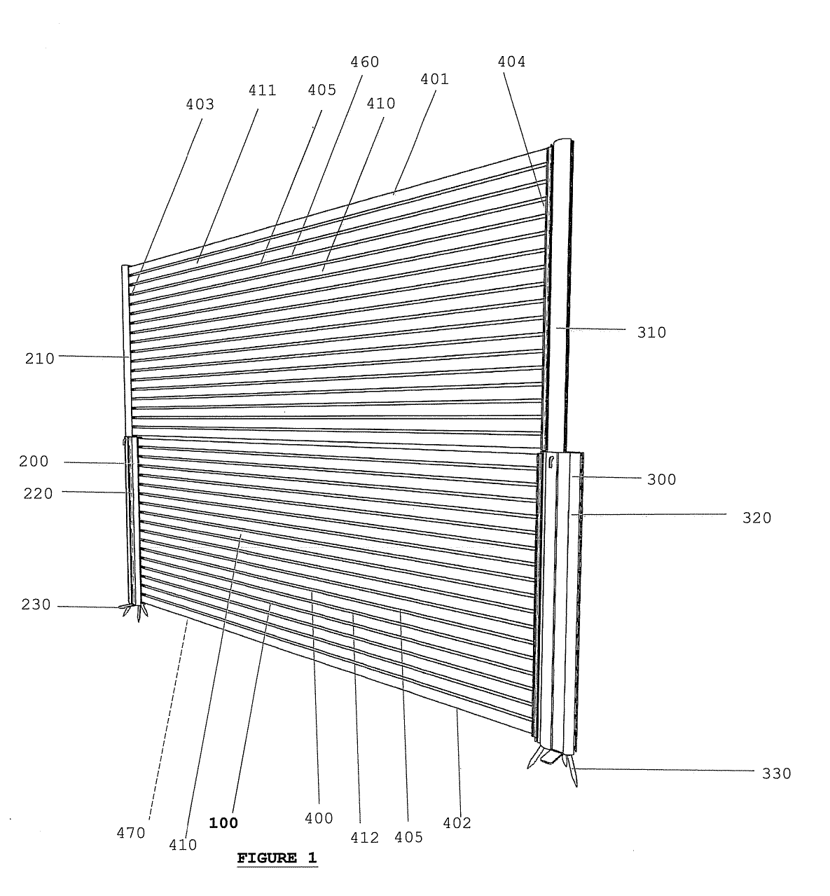

FIG. 1 illustrates, by way of example, the overall components of the portable barrier 100. As shown, the portable barrier 100 includes three primary components: a first vertical assembly 200, a corresponding second vertical assembly 300 and a retractable screen 400 positioned between both vertical assemblies 200 and 300. Preferably, the retractable screen 400 includes a plurality of perforations 405. Such perforations 405 should be sufficient to allow enough air to pass through the portable barrier 100 to reduce the risk of toppling the device during normal wind conditions. As shown in FIG. 1, the perforations 405 may be positioned equidistant from one another.

As shown, the retractable screen 400 includes an upper edge 401, a corresponding bottom edge 402, a first edge 403 and a corresponding second edge 404. While the retractable screen 400 may take a variety for shapes and orientations, it is preferably rectangular or square. Moreover, the retractable screen 400 may be thin, bendable and pliable having a first panel 460 and a corresponding second panel 470 (positioned opposite the first panel 460). While the retractable screen 400 can be made of a variety of weather proof and durable materials, it is preferably corrugated aluminum. However, the invention also contemplates use of a metal mesh screen, a woven rope matrix, as well as a variety of bendable fabrics for the retractable screen 400.

As further shown in FIG. 1, the first vertical assembly 200 and the second vertical assembly 300 mirror each other in size, shape, height, dimension and functionality. Moreover, both vertical assemblies 200 and 300 are preferably parallel to one another and made of a lightweight, durable and rigid material such as aluminum. As shown, the first vertical assembly 200 has three primary components: a top section 210, a middle section 220, and a bottom stand 230. Likewise, the second vertical assembly 300 includes a top section 310, a middle section 320 and a bottom stand 330. Both bottom stands 230 and 330 function to secure the portable barrier 100 to a variety of terrains including, but not limited to, asphalt.

### The Vertical Assemblies

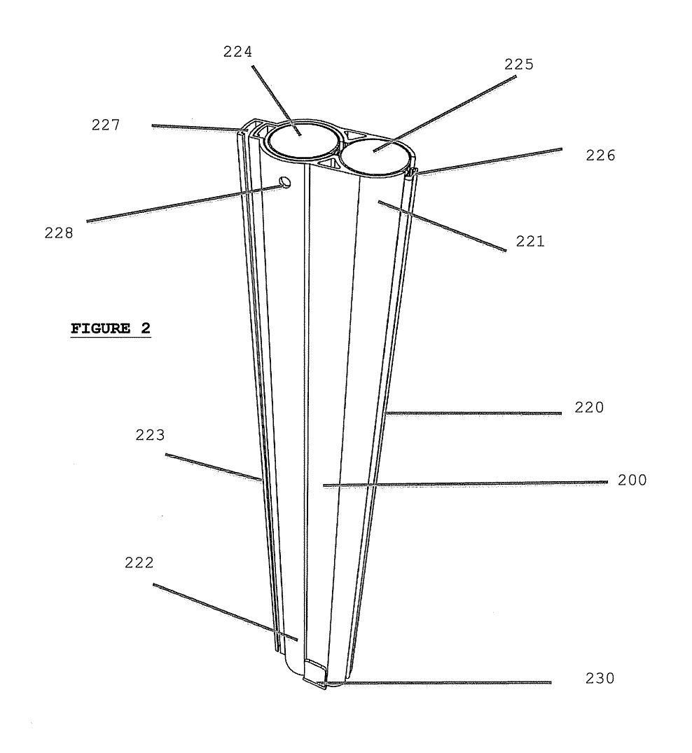

FIG. 2 through 4 illustrate, by way of example, one embodiment of a vertical assembly 200 that forms part of the portable barrier 100. FIG. 2 shows one preferred shape and configuration for the middle section 220 of the vertical assembly 200. Such middle section 220 includes a top end 221 and corresponding bottom end 222. As further shown in FIG. 2, the middle section 220 includes an outer housing 223 that is preferably elliptical in cross section. Positioned within the elliptical outer housing 223 are both a first tubular barrel 224 and a corresponding second tubular barrel 225. Both tubular barrels 224 and 225 are maintained parallel and proximate to each other within the shaft of the elliptical outer housing 223.

Either tubular barrel (224 or 225) is capable of receiving and maintaining the top section 210 of the first vertical assembly 200. Moreover, the tubular barrels 224 and 225 function so as to allow custom vertical positioning of one or more top sections 210. This allows an emergency response professional to select and determine a desired vertical height of the adjustable barrier—to ensure complete concealment of the cause of traffic congestion (i.e., an auto accident, construction project, etc.).

As further shown in FIG. 2, the elliptical outer housing 223 may include both a male fastener 226 and a female fastener 227. Preferably, the male fastener 226 is on the opposite side of the elliptical outer housing 223 in comparison to the female fastener 227. Under such arrangement, a plurality of portable barriers 100 can be attached to one another for purposes of creating an elongated screen—in scenarios where the root of the traffic congestion is large (i.e., a collision dealing with multiple vehicles). This is accomplished by engaging a male fastener 225 of one middle section 220 through a female fastener 226 in a second middle portion 220. As such, this allows customization through use of multiple separate portable barriers 100.

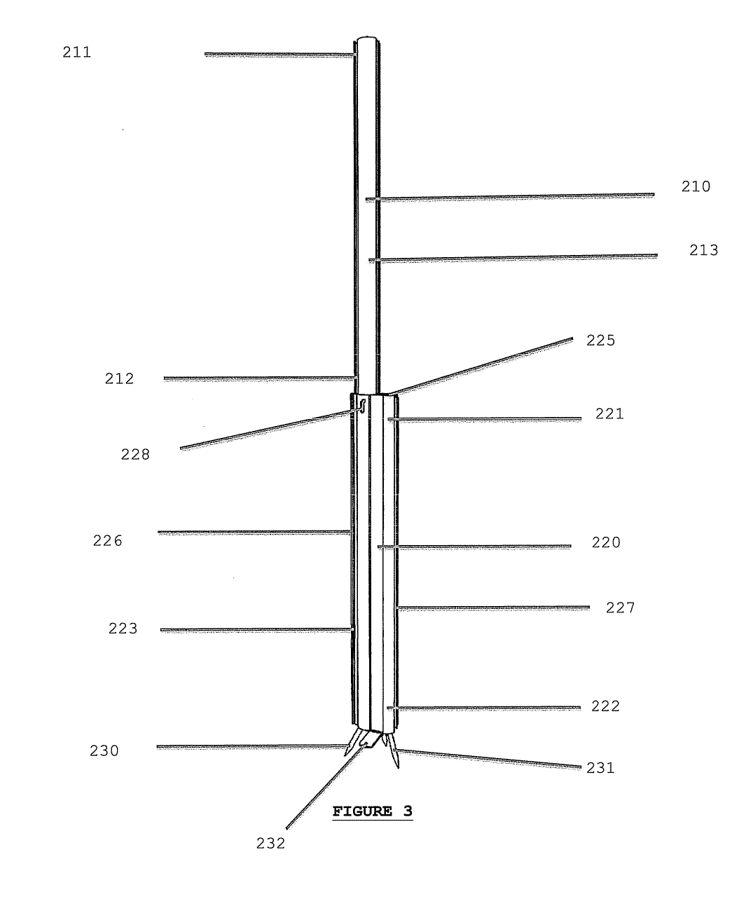

FIG. 3 illustrates, by way of example, the positioning of the top section 210 above the middle section 220 of the vertical assembly 200. As shown, the top section 210 is cylindrical in shape and construction having a top side 211, a corresponding bottom side 212 and a tubular shaft 213. As further shown in FIG. 3, a portion of the bottom side 212 is positioned within the top end 221 of the middle portion 220.

Both FIG. 2 and FIG. 3 illustrate how the middle portion 220 may include an adjustor key 228 sufficient to regulate the height of the top section 210. As shown the adjustor key 228 can engage and secure the bottom side 212 of the top section 210 at various portions along its tubular shaft 213. This again allows custom selection of the appropriate overall height of the adjustable barricade 100.

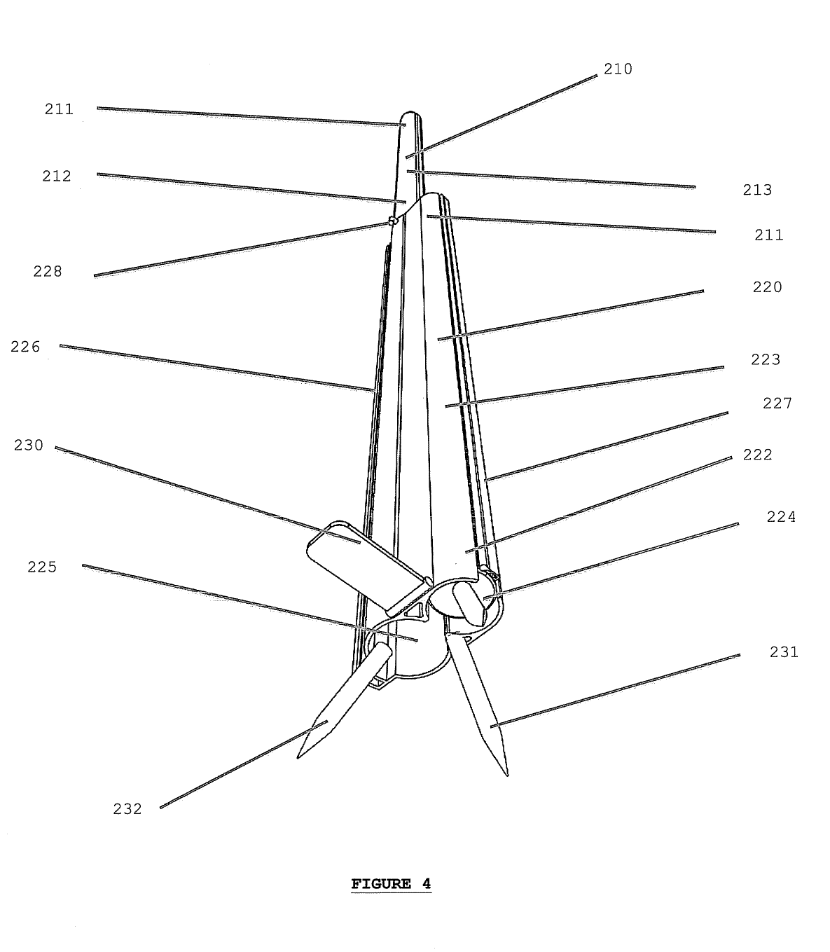

FIG. 4 illustrates, by way of example, one form of the bottom stand 230 of the vertical assembly 200. As shown, the bottom stand 230 is positioned proximate the bottom end 222 of the middle section 220 (as further shown and illustrated in FIG. 1). While the bottom stand 230 may take several forms, it is preferably a tri-pod 231 having three legs 232 which radially emanate from the middle section 220. Another contemplated form of the bottom stand 230 is a flat panel positioned perpendicular to the middle section 220. Regardless of design, such bottom stand 230 should be sufficient to engage the conditions proximate the site of traffic congestion (i.e., gravel, dirt, asphalt, etc).

### Retractable Screen

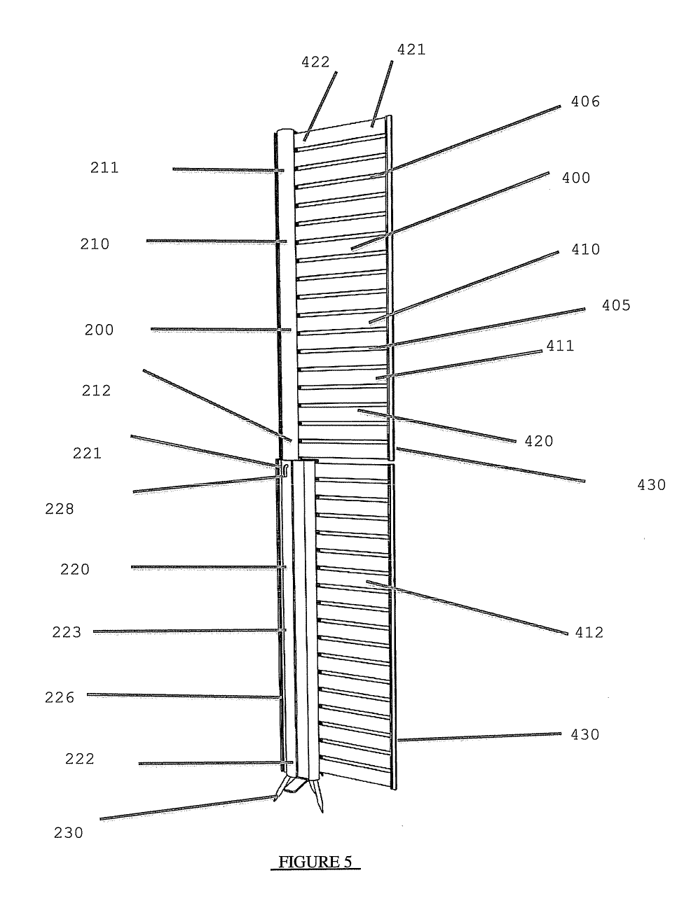

FIGS. 5 through 8 illustrate, by way of example, one embodiment of the retractable screen 400. First turning to FIG. 5, the retractable screen 400 is preferably positioned within the first vertical assembly 200. In addition (and/or alternatively), this (or a second) retractable screen 400 may be positioned within the second vertical assembly 300. As previously, addressed the retractable screen 400 is capable of extending from the first vertical assembly 200 and connected to the second vertical assembly 300. Once assembled and connected, both vertical assemblies (200 and 300) maintain and hold the retractable screen 400 to obstruct and conceal any type of auto accident, construction or similar event—to reduce gawking which often causes or increases traffic congestion.

The retractable screen 400 is made of a flexible, bendable and conforming layer of material(s) that can be removed from the first vertical assembly 200 and later returned, through retraction, to that vertical assembly 200. As previously addressed, it can be made of a flexible aluminum (or similar metal), a mesh screen, a woven rope matrix, as well as a variety of bendable fabrics. The system may include a series of parallel horizontal straps 420—which cause a number of gaps 406 that create the necessary perforations 405 to allow air to pass.

Removal and retraction may be accomplished through a variety of means contemplated by the invention. One means contemplated is simply unrolling the retractable screen 400 and manually attaching it to the male and female fasteners (226 and 227) located on both the first vertical and second vertical assemblies 200 and 400. As shown and illustrated in FIG. 4, the preferred embodiment includes a retractable screen 400 that may be manipulated through use of a rotatable crank positioned proximate the top end 211 of the top portion 210. In addition (or in the alternative), a spring-loaded member may be located within the first vertical assembly 200 (or alternatively the second vertical assembly 300) to aid in retraction. This would be preferably located in both the top portion 210 and the bottom portion 220 of the vertical assembly 200—specifically one or more tubular barrels (224 and/or 225).

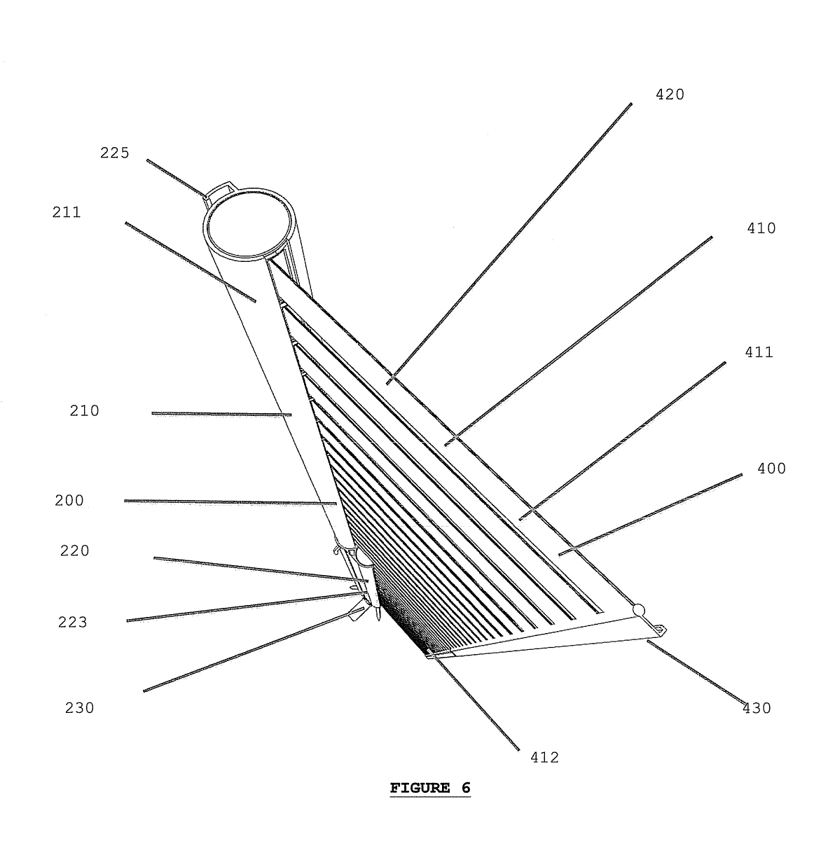

As shown in both FIG. 5 and FIG. 6, there are two partitions 410 of the retractable screen 400: an upper partition 411 and a lower partition 412. Both partitions 410 mirror each other in terms of components, size, dimension and functionality—as well as materials used to create both sections of the retractable screen 400. The upper partition 411 is housed, maintained, removed and later retracted via the top section 210 of the vertical assembly 200. Similarly, the lower partition 412 is maintained and stored (for later use) within the middle section 220 of the vertical assembly 200.

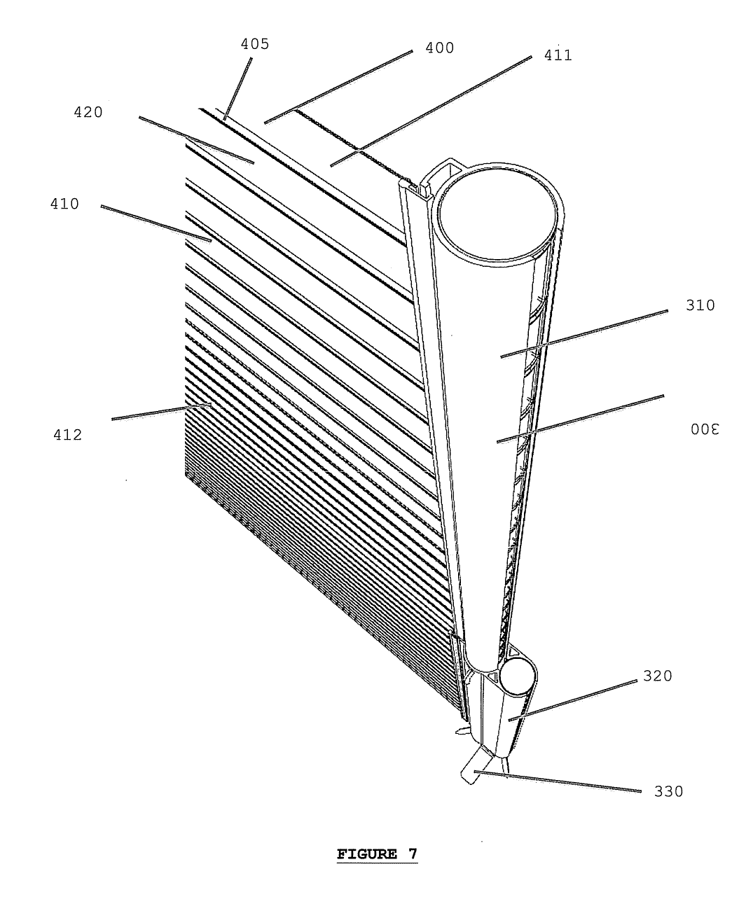

First turning to the first partition 411 shown in FIG. 7, this component of the retractable screen 400 includes a plurality of horizontal straps 420. Each strap 420 is parallel to one another and includes a gap 406 sufficient to create a perforation 405. As further shown in FIG. 5, each horizontal strap 420 has an outer edge 421 and an inner edge 422. The inner edge connects within the first vertical assembly 200. Such connection can occur within either of the tubular barrel (224 or 225) illustrated in both FIG. 2 and FIG. 3. As previously described, the inner edger 422 may also connect with a rotatable crank shaft and/or a spring loaded member.

As shown and illustrated in FIG. 5, the outer edge 421 of each horizontal strap 420 is removably attached to a vertical fastener 430. The vertical (male) fastener 430 is capable of being removed from the first vertical assembly 200, stretched, and then connected to the female fastener 227 of the second vertical assembly 300.

As shown in both FIG. 5 and FIG. 6, there are two functionalities created by the configuration of the plurality of horizontal straps 420 which connect to the vertical fastener 430. First, by allowing one or more straps 420 positioned in the lower portion of the first partition 411 to be removed from the vertical fastener 430—this allows the top portion 210 to be vertically adjusted (up or down) in reference to the middle portion 220. The result is that the height of the portable barrier 100 may be regulated and optimized based upon the nature of the root cause of the traffic congestion.

The second benefit of this assembly is that the female fastener 227 positioned on each vertical assembly 200 may be affixed to either a male fastener 226 (located on a related vertical assembly 300) or alternatively the vertical fastener 430. This interchangeability allows two or more portable barriers 100 may be attached to one another in series to create an elongated and customized shield to hide a large or obstructive auto accident, construction or other issue.

### Alternative Bottom Stands

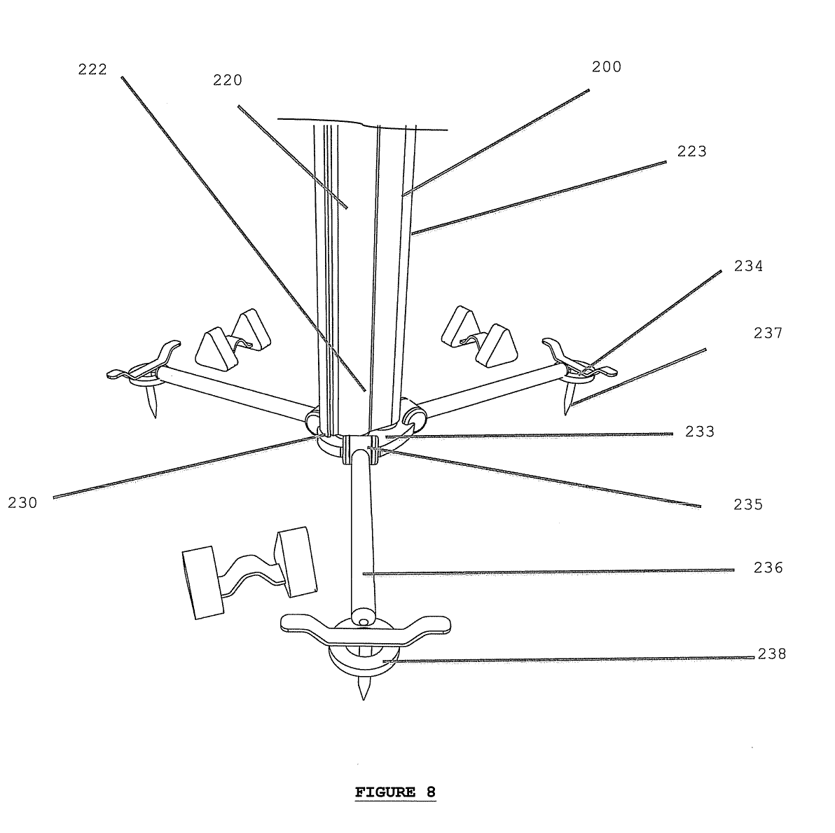

Both FIG. 4 and FIG. 8 illustrate two alternative embodiments of bottom stands 230. While both embodiments are completed, one of ordinary skill in the art, upon review of this disclosure, shall contemplate and realize other related structures. Regardless of form, the bottom stand 230 is affixed to the bottom end 222 of the middle portion 220 of both vertical assemblies 200 and 300. Preferably, the bottom stand 230 is oriented to adhere and stick to a variety of surfaces likely near the source of a traffic accident, such as gravel, asphalt or dirt.

As shown in FIG. 4, the bottom stand 230 may take the form of a tri-pod having three or more legs 232 that emanate from the elliptical outer housing 223 of the middle portion 220. These legs 232 can rotate into a suitable position or alternatively be telescopic. As a similar construction, the bottom stand 230 could take the form of a flat plate affixed perpendicular to the elliptical outer housing 223.

FIG. 8 illustrates, by way of example, a more robust bottom stand 230 in the form of three or more swivel stabilizers 233. Such bottom stand 230 should be particularly used in soft ground conditions, such as gravel or dirt. Each swivel stabilizer 233 includes three primary components: a claw 234, a hinge 235, and a connecting rod 236. As further shown in FIG. 8, the connecting rod 236 is tubular in shape and construction. Moreover, the connecting rod 236 has a sufficient length to bridge and affix the claw 234 to the hinge 235. While the claw 234 may take many a form, it preferably includes two parts: a spike 237 and a base 238. The spike 237 may be driven into the soft ground in order to stabilize the portable barrier 100. Likewise, the base 238 engages the surface of the ground.

### Warning Beacon

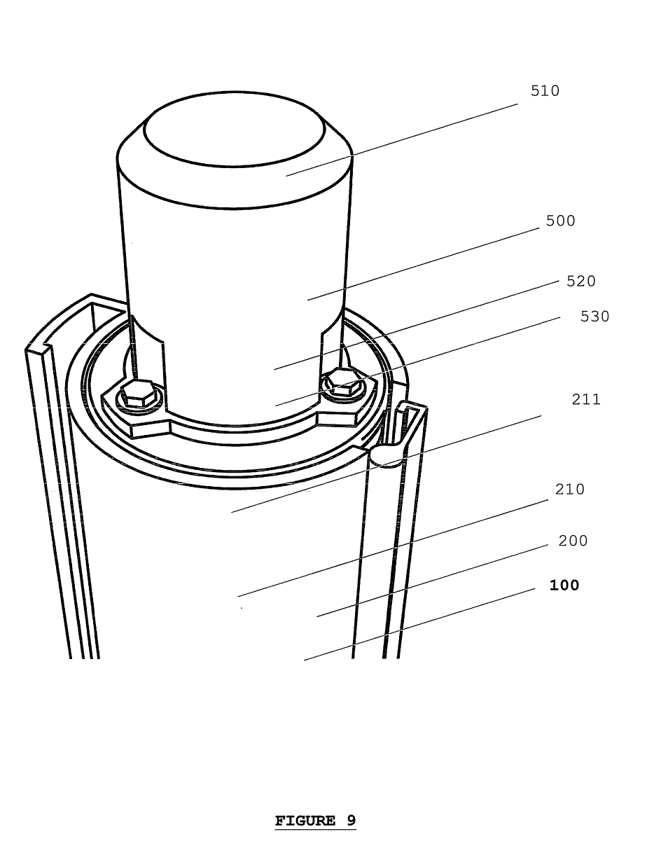

FIG. 9 illustrates, by way of example, additional functionality and safety features that can be included on the portable barrier 100. As shown, one initial safety feature can be a warning beacon 500. The warning beacon 500 may include a flashing light 510 and an energy source 520, which can take the form of a battery 530. While the warning beacon 500 can be positioned at a variety of points on either vertical assembly 200 or 300, it is preferably located on the top end 211 of the top portion 210.

Additionally, the retractable screen 400 can include reflective materials. As such, both the retractable screen 400 and warning beacon 500 can help alert drivers of the existence of the portable barrier 100 to avoid collisions and thus causing additional traffic congestion.

That which is claimed is:

1. A portable barrier to obstruct viewing the source of traffic congestion, the portable barrier comprising:
a first vertical assembly and a second vertical assembly, each vertical assembly having a top portion, a middle portion, and a base stand, wherein each middle portion includes at least one tubular barrel capable of receiving the top portion and a first fastener; and
a retractable screen operable to be drawn from and retract into the first vertical assembly, the retractable screen having one or more partitions which include a plurality of parallel horizontal straps attached to a vertical fastener which engages the first fastener located on the second vertical assembly.

2. The portable barrier of claim 1, wherein the middle portion further comprises:
an outer housing having a first tubular barrel and a second tubular barrel, wherein the barrels are generally parallel to each other and capable of receiving the top section; and
an adjustor key positioned along the outer housing sufficient to regulate the height of the top section within the barrel.

3. The portable barrier of claim 2, wherein the outer housing further includes a second fastener on an opposite side of the housing in comparison to the first fastener. the second fastener capable of engaging a second vertical assembly in order to lengthen the portable barrier.

4. The portable barrier of claim 2, wherein a rotatable crank on the first vertical assembly is operable for releasing and returning the retractable screen.

5. The portable barrier of claim 1, wherein the retractable screen includes a first panel and corresponding second panel and comprises:
an upper partition positioned within the top portion of the first vertical assembly; and
a lower partition positioned within the middle portion of the first vertical assembly.

6. The portable barrier of claim 5, wherein the retractable screen is made from a flexible, bendable and conforming layer of material.

7. The portable barrier of claim 1, wherein the bottom stand comprises a swivel stabilizer having a claw, a hinge affixed to the middle portion of the vertical assembly and a connecting rod having a sufficient length to affix to the claw and the hinge.

8. The portable barrier of claim 7, wherein the claw includes a base and a spike capable of piercing and engaging a support.

9. The portable barrier of claim 1, wherein the top portion of the vertical assembly includes a warning beacon having a flashing light powered by a battery.

10. A portable barrier comprising:
a first vertical assembly;
a second vertical assembly having a female fastener; and
a retractable screen that is drawn from and retracts into the first vertical assembly, the retractable screen having one or more partitions which include a plurality of parallel horizontal straps attached to a vertical fastener engaging the female fastener located on the second vertical assembly; and
a first base stand and a corresponding second base stand, wherein each base stand is attached to a vertical assembly.

11. The portable barrier of claim 10, wherein each vertical assembly has a top portion, a middle portion, and a base stand, and wherein each middle portion includes at least one tubular barrel capable of receiving the top portion and a female fastener.

12. The portable barrier of claim 11, wherein the middle portion further comprises:
an elliptical outer housing having a first tubular barrel and a second tubular barrel, wherein both barrels are parallel to each other and capable of receiving a top portion; and
an adjustor key positioned along the elliptical outer housing sufficient to regulate the height of the top section.

13. The portable barrier of claim 12, wherein the elliptical outer housing further includes a male fastener on the opposite side of the elliptical housing in comparison to the female fastener, the male fastener capable of engaging another vertical assembly in order to length the portable barrier.

14. The portable barrier of claim 12, wherein a rotatable crank on the first vertical assembly is operable for releasing and returning the retractable screen.

15. The portable barrier of claim 10, wherein the retractable screen includes a first panel and corresponding second panel and comprises:
an upper partition positioned within the top portion of the first vertical assembly; and
a lower partition positioned within the middle portion of the first vertical assembly.

16. The portable barrier of claim 15, wherein the retractable screen is made from a flexible, bendable and conforming layer of material.

17. The portable barrier of claim 10, wherein the bottom stand comprises a swivel stabilizer having a claw, a hinge affixed to the middle portion of the vertical assembly and a connecting rod having a sufficient length to affix to the claw and the hinge.

18. The portable barrier of claim 17, wherein the claw includes a base and a spike capable of piercing and engaging soft ground.

19. The portable barrier of claim 10, wherein the top portion of the vertical assembly includes a warning beacon having a flashing light powered by a battery.
